(19) United States
(12) Patent Application Publication
(10) Pub. No.: US 2012/0245950 A1
(43) Pub. Date: Sep. 27, 2012

(54) SYSTEM AND METHOD FOR DETERMINING ASSET DIFFERENTIATION IN MEDICINE DEVELOPMENT

(75) Inventors: Eileen Morrissey, Mendham, NJ (US); Jim Anderson, Scottsdale, AZ (US)

(73) Assignee: MEDICINE DIFFERENTIATION ANALYTICS, LLC, Mendham, NJ (US)

(21) Appl. No.: 13/426,935

(22) Filed: Mar. 22, 2012

Related U.S. Application Data
(60) Provisional application No. 61/467,231, filed on Mar. 24, 2011.

(51) Int. Cl. G06Q 50/22

(52) U.S. Cl. 705/2

(57) ABSTRACT

A computer implemented system and method of determining pharmaceutical asset market potential is disclosed. The system and method comprising: collecting asset information of a proposed pharmaceutical asset; determining a therapeutic category of the proposed pharmaceutical asset; determining an unmet need for proposed pharmaceutical asset by evaluating a plurality of Customer Value Statements (CVS) based on the therapeutic category. Also disclosed, the system and method computes a differentiation score based on the plurality of CVS and comparing a strength of the proposed pharmaceutical asset against existing competitor data in the therapeutic category and computes a Real/Win/Worth (RWW) score to determine the probability of success of the proposed pharmaceutical asset in the therapeutic category based, in part, on the differentiation score; and CVS. The disclosed system and method additionally generates an executive summary report of the proposed pharmaceutical asset market potential base, in part, on the RWW score.

### CROSS REFERENCE TO RELATED APPLICATIONS

This application claims the benefit of U.S. provisional application No. 61/467,231 filed on Mar. 24, 2011, the contents of which are herein incorporated by reference.

### TECHNICAL FIELD

The present invention relates generally to a system and method for evaluating medicines for continued investment and/or development of the same.

### BACKGROUND TO THE INVENTION

The pharmaceutical industry in the US and Europe, the largest markets in the world have transitioned from a Growth Stage to a Competitive Stage of its lifecycle. With fewer new products, stagnant markets, price ceilings, and increasing brand and generic competition, pharmaceutical companies are fighting an increasingly intense battle to produce successful products on the market.

In the meantime, global emerging markets are charging through their growth or “commercial stage,” marking them as the new battlegrounds for competition.

Recently, the payer community (i.e., insurance companies) has gained strength and now determines whether a certain medicine can gain access to patients and at what price. Insurance companies often do not give access and/or pay a price premium, unless the new drug is significantly differentiated over other cheaper and often generic alternatives.

Patients and caregivers are far more educated today and are in a position to make choices for managing their health. Alternatives, such as once daily versus once monthly or intravenously versus orally are life style options patients' care about, along with efficacy, tolerability, and safety.

Nearly every country in the world tries to reduce health care programs due to budget constraints. In the US, the Comparative Effectiveness Research (CER) program in the current Healthcare bill requires pharmaceutical companies to compare their potential new medicine to other alternatives in head-to-head and very costly trials to prove which one is differentiated. A mechanism to prove differentiation without costly head to head trials is warranted.

As a result, the days of blockbuster sales at high margins are over. Pharmaceutical companies must produce products that not only meet safety and efficacy standards to gain approval, but also demonstrate its additional benefits outweigh healthcare costs in the short or long run so that payers are willing to pay for and give patients access to the medicine. Further, pharmaceutical companies must show that their products have an edge over other existing alternatives in order to ensure that prescribers will prescribe and patients will be willing to take the medicine.

Current evaluation solutions to research certain disease areas (also referred to as therapeutic area (TA)) for competing data are very manually intensive. Further, the research results are often lost and not used again or shared with others in the same disease area. The research is typically focused on the size of the market and customer focused data, but not on specific parameters to determine differentiation by comparing an asset to competing alternative treatments.

Lastly, new drugs for certain disease areas are often not evaluated against the unmet need in the market. In other words, the science may be real, but it may not fit a need from a payer, prescriber, patient or approvers view. For example, a new drug may be better than a placebo, but current evaluation solutions do not determine, for example, if the new drug will be better than generic alternatives and if the payers will give access or pay for the new drug.

It would therefore be advantageous to provide an efficient and effective evaluation solution for determining how differentiated a new drug will be in the market.

### SUMMARY OF THE INVENTION

Certain embodiments disclosed herein include a computer implemented method for determining pharmaceutical asset the market potential. The method comprises collecting asset information about in-line and proposed pipeline products of pharmaceutical assets by a therapeutic category; determining an unmet need for the proposed pharmaceutical asset by evaluating a plurality of customer value statements (CVS) based on the therapeutic category; computing a differentiation score based on the plurality of CVS and comparing a strength of the proposed pharmaceutical asset against existing competitor pharmaceutical assets in the therapeutic category; and generating an executive summary report of the proposed pharmaceutical asset market potential base, in part, computed differentiation score.

Certain embodiments disclosed herein also include a system for determining pharmaceutical asset market potential. The system comprises at least one application server; at least one non-transitory storage device in communication with the at least one application server; a pharmaceutical asset differentiation process residing on the at least one application server and executed therein, and accessed by a at least one computer system, wherein the least one application server is configured to perform the pharmaceutical asset differentiation process including: collecting asset information of in-line and proposed pipeline products of pharmaceutical assets by a therapeutic category; determining an unmet need for the proposed pharmaceutical asset by evaluating a plurality of customer value statements (CVS) based on the therapeutic category; computing a differentiation score based on the plurality of CVS and comparing a strength of the proposed pharmaceutical asset against existing competitor pharmaceutical assets in the therapeutic category; and generating an executive summary report of the proposed pharmaceutical asset market potential base, in part, computed differentiation score.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention will be apparent from the following detailed description taken in conjunction with the accompanying drawings.

FIG. 1 is a flowchart of a process to complete the Differentiation Analysis according to an embodiment of the invention.

FIG. 2 is a schematic view of the inputs and outputs of the step of establishing the foundational information on the asset.

FIG. 3 is a schematic view of the inputs and outputs of the step of establishing the unmet need by customer group.

FIG. 4 is a schematic view of the inputs and outputs of the step of determining how to measure differentiation for this asset.

FIG. 5 is schematic a view of the inputs and outputs of the step for establishing ideal Label Claims to achieve differentiation in the market.

FIG. 6 is a schematic view of the inputs and outputs of the step of determining the probability the asset will gain access and reimbursement in key markets.

FIG. 7 is a schematic view of the inputs and outputs of the step of scoring an asset opportunity.

FIG. 8 is a schematic view of the inputs and outputs of step for establishing executive reporting at an asset and portfolio level.

FIG. 9 illustrates the analysis of the HDI according to an embodiment of the invention.

FIG. 10 illustrates the correlation and interpretation of CVS Value scores to HDI differentiation scores according to an embodiment of the invention.

FIG. 11 is a block diagram illustrating the implementation of the system according to an embodiment of the invention.

### DETAILED DESCRIPTION OF THE INVENTION

The embodiments disclosed herein are only examples of the many possible advantageous uses and implementations of the innovative teachings presented herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

Certain exemplary embodiments disclosed herein include a system and method for determining how differentiated a potential medicine (a pharmaceutical asset) will be when it launches on the market compared to its competitors and how aligned the assets differentiation features are to the unmet needs from various customer groups. The customer groups include, but are not limited, to patients, prescribers, hospitals, caregivers, payers, approvers, and the like.

Specifically, by knowing what a disease area the potential asset is in, the system and the method thereof populate the unmet needs from various customer groups, parameters by which differentiation is evaluated for this disease area, how each competitor (in-line or pipeline) ranks on each parameter. The user is then prompted to add their asset's information and data. The system and method thereof then compute a differentiation score for the asset and a series of executive level reports at both the product and the portfolio level. The overarching outcome of the embodiments disclosed herein is a decision to invest or not to invest in a potential pharmaceutical asset to the next phase of development and/or the ability for patients and doctors to make the right choice of treatment for a patient.

Certain exemplary embodiments of the invention include a system for storing disease area information and computing differentiation scores on pre-determined disease area parameters that determines, in part, the likelihood a future pharmaceutical asset will be, for example, but not limiting to, approved over other alternatives, paid for and provided access to patients over other alternatives, prescribed over other alternatives, and taken over other alternatives.

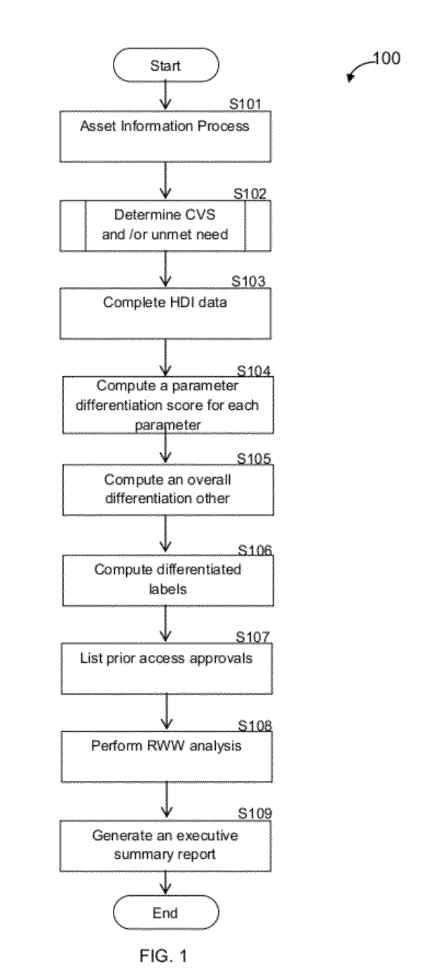

FIG. 1 depicts an exemplary and non-limiting flow chart 100 of a process to determine differentiation for one potential new pharmaceutical asset and to evaluate the same asset against a portfolio of other opportunities. A pharmaceutical asset may include, but is not limited to, a biological asset, a medicine, a drug, a compound, a medical device, a new treatment procedure, and the like. A pharmaceutical asset will be also referred to herein as an “asset”.

At S101, the asset information is entered. The asset information includes, but is not limited to, a name of the asset, a specific disease area addressed by this asset, a stage of development, a project leader, an estimated date for future phase completions, and so on. The asset information may be provided by an asset team leader or an insurance analyst. Once the disease area for the asset is established, the data related to the disease area is retrieved and may be displayed to the user. The retrieved data may include, for example, competitors, known unmet needs, customer value statements, label claims, recommended parameters on a healthcare differentiation instrument (HDI), outcome measures, current standard of care, and so on.

The customer value statements (CVS) and/or the unmet need are related to the same disease area and are provided by a customer group (e.g., patients, payers, approvers, caregivers and prescribers). The recommended parameters on the HDI allows the ability to measure differentiation based on the CVS and/or unmet need data. The categories for these recommended parameters are typically efficacy, safety, tolerability, convenience, and cost. The parameters are often common and standard for a given disease area. For example, measuring differentiation in Diabetes may be very different than the measurements in Lung Cancer.

For each parameter the data presented on all competing products include a rigor level demonstrating how much supporting data is available (e.g., published label versus best guess). A parameter may be an outcome measure, a pharmaceutical asset efficacy, a pharmaceutical asset safety, a pharmaceutical asset tolerability, a pharmaceutical asset convenience, and a pharmaceutical asset cost. It should be noted that rigor levels are used by the disclosed process to determine the amount of facts and analysis that went into the data. The source for rigor levels can vary from published articles or labels, to marketing materials, to statements in annual reports, to verbal statements, to best guesses. It should be noted that using rigor levels provides transparency to the user making a decision on complete or often incomplete data. For example, in early stage drug development, it is not expected that significant published data would be available. Best guesses are expected. However, in later stages, it is expected that more facts and published information are available. Thus, having knowledge on the rigor levels would allow governance or investment bodies to take more informed decisions.

At S102, the Customer Value Statements (CVS) or unmet need for the determined disease area are determined and displayed. Optionally, the CVS may be verified and updated as needed, for example, by a user.

At S103, the user completes the HealthCare Differentiation Instrument (HDI). The process has already populated the parameters data for in-line and pipe-line competition. The parameter data is now entered or updated for their respective asset on the HDI. The parameters may be entered by the user. This includes both their assets target/planned data as well as observed data through recent pre-clinical or clinical trials. Then any changes made are tracked and report.

At S104, a differentiation score is computed for each and every parameter. The parameter differentiation score defines how uniquely differentiated the asset is going to be over current and future treatments for one parameter. As an example, if the disease area is Alzheimer and the parameter category is efficacy, and the parameter is the number of months delayed onset of disease, and the proposed asset in current clinical trials demonstrate 6 to 9 months while the current standard of care is 0 month; and the pipeline competitors have trial results at 3 months to 5 months delayed onset of the disease, then this asset is Positively Differentiated on the number of months delayed parameter, i.e., 6 to 9 months is better than 0 to 5 months.

In this example, the proposed asset is differentiated on the number of months delayed parameter. It is more likely that this asset will be chosen over the other alternative medicines based on this parameter alone. The user must look at the other parameters to determine if the asset has differentiation in other important categories. In one embodiment, the process determines which parameters are more closely aligned with important CVS's.

At S105, an overall differentiation score is calculated based on the result of the individual parameter differentiation scores. The computed overall differentiation score is then compared to one or more CVS importance scores. In one embodiment, the CVS importance scores are entered having been determined by the customers based on questionnaires (e.g., cost is most important CVS for payers in MS products). In other embodiment, the CVS importance scores are retrieved from the database.

If their asset is not differentiated in areas critical to the unmet needs, then no further investment should be made on this asset. The overall differentiation scores for the asset are also compared to averages and highs/lows of overall differentiation scores in the respective disease area.

In one embodiment of the invention, the process 100 ensures that a label claim can be obtained. That is, the exact wording of the proposed label to be published with the asset (e.g., medicine) is planned when the asset is developed. This is in deference to current practice where the label wording is not discussed until the close to regulatory approval. With this aim, at S106, computes and suggests one or more label claims to be associated with the asset, preferably prior to clinical trials. A computed label claim is referred to as a “differentiated label”.

Differentiated labels are based on the differentiated parameters in the HDI. In other words, if an asset is differentiated in an HDI category such as administration, then the process highlights the need to have uniquely defined wording in the differentiated labels in the administration section of the differentiated label based on the data from that HDI parameter. In one embodiment, the asset's differentiated label claims are aligned with a corresponding label sections. For example, indications and usage, dosage and administration, adverse reactions, and so on. In one embodiment, at S106, the wording of competitor claims in these sections is populated to allow comparisons with the suggested labels claim against competitors' label claims.

In one embodiment, the user lists the trials planned to approve the label claims computed by the process. Based on the strength of the link from CVS to HDI to a differentiated label claim, the probability of achieving that differentiated label claim is computed.

In one embodiment, with the strengthening of the payer community, it is important to ensure that investments are made only in assets with a high probability of gaining access into insurance plans at the desired reimbursement levels.

With this aim, at S107, prior access approvals and denials are listed for this disease area by an entity making the decision. Such an entity may be, for example, national healthcare institutes, health care insurance companies, and other payers of healthcare costs. Given the strength of the differentiation scores, a probability that the asset will gain access with each of these entities.

At S108, a scoring on the Real/Win/Worth (RWW) analysis based on the results of prior steps is performed to compute RWW scores. This is performed using information including one or more of CVS, HDI parameter, differentiated label, entities, and differentiation scores. In addition, it may be requested that additional information be entered as determined by the process (e.g., expected price and profit). All of this cumulates into a set of RWW scores. Thus, according to certain embodiments based on the computed RWW scores it can be determined how real the proposed asset is, for example, based on the likelihood the asset will be prescribed, approved, taken, and paid for over other alternatives. The ability to “win” in the market with this asset. This is determined based in part on the assets differentiation scores and other questions asked of the team relating to cycle times, investments required, market position, and so on. It is determined that the investment is “worth” based in part on the assets financial and non-financial awards such as ROI (return on investment) and reputation.

Much of the RWW scores are generated based on the user inputs, HDI, CVS, label claims, and access scoring. The Real/Win/Worth analysis also includes rigor scores. In one embodiment, the scores computed by the process are compared to averages in the disease area.

At S109, an executive summary report is produced. The report, in one embodiment, includes a standard set of executive level charts at the asset and portfolio level. The report can be used by governance boards to decide if further investment in this asset is warranted. In addition, error reports are created for review prior to their final presentation to the governance board.

In one embodiment, all information computed and gather during the execution of the process 100 is saved in a database according to the disease area. The information saved in the database can be used for future analysis of an asset in the same disease area.

In certain embodiment of the invention, the differentiation process 100 is performed each time a decision needs to be made to fund an asset to its next stage of development (e.g., Phase I to II or Phase II to III). Historical data is automatically maintained in a database.

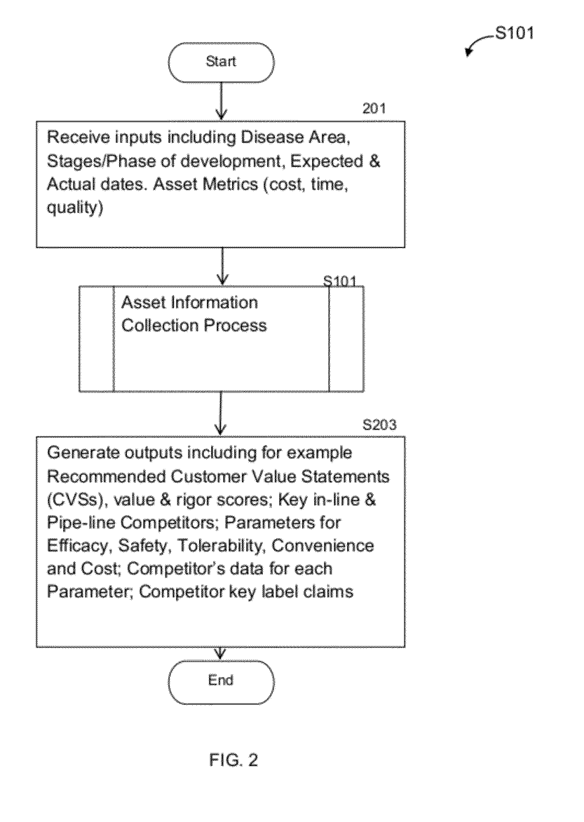

FIG. 2 depicts an exemplary and non-limiting schematic diagram of the S101 of collecting of asset information. At S201, the asset information is gathered through user inputs. In an embodiment, the inputs at S201 include, but are not limited to, therapeutic category and disease area for the asset and basic demographic information about the asset. The disease area is a sub-set of the therapeutic category. For example, the therapeutic category may be “Oncology” and the disease area may be “Lung Cancer”. The disease area is a critical reference key for the asset. Information from assets are recorded and maintained in the database by disease area. Therefore, as the disease area is identified for a new asset, information from previous assets from in the same disease area is used to pre-populate certain information, such as competitors, CVS, and HDI parameters. The user may enter and maintain the other asset-related information.

The collection steps outputs, at S203 which are populated data (e.g., based upon disease area) and provides a starting point for the analysis. In one embodiment, based on the disease area identified for the asset, the other pieces of information can be pre-populated as indicated S203 of FIG. 2.

In one embodiment, there is an ability to override and continue to maintain the pre-populated data. Pre-populating this information has several benefits, such as consistency across assets (e.g., assets in the same disease area should have similar competitors); Robust data set, i.e., forces the asset team to consider previous/existing information from assets of the same disease area (e.g., CVS); comparability, i.e., by using similar data sets the differentiation process can provide comparisons across multiple assets, such as portfolio report; and speed, i.e., reduce cycle time to prepare the analysis.

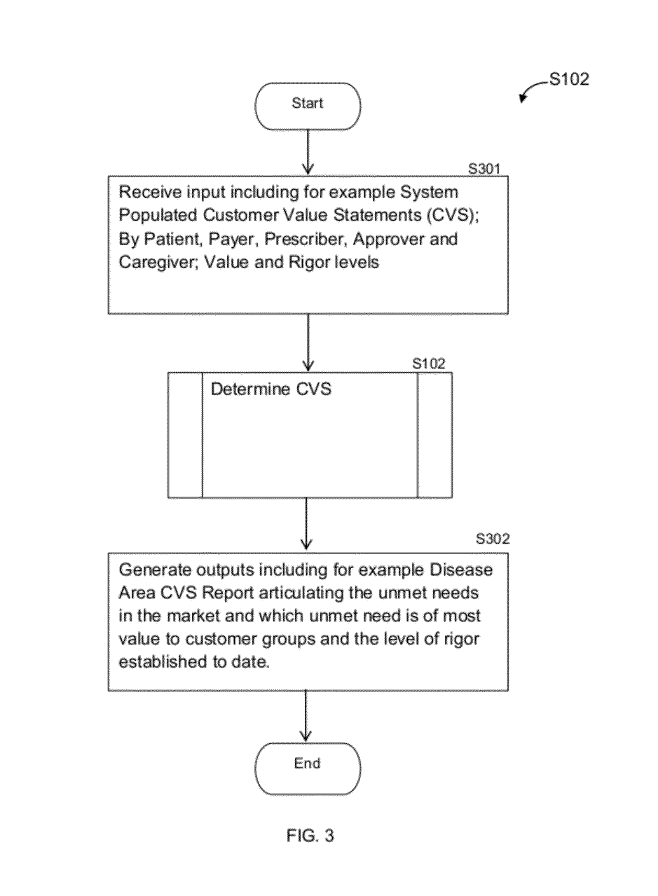

FIG. 3 shows an exemplary and non-limiting schematic diagram of the CVS verification performed during S102 of FIG. 1. As previously discussed, the differentiation process populates based on information already stored by disease area in the database. At S301, the information in the populated input data is reviewed and edited to insure it accurately reflects their assessment of customers' perspectives on this disease area (i.e., due to recent changes in the market). The populated data may include system generated CVS categorized by one of more of the following groups patients, payers, prescriber, approver, and caregiver. Each input may be associated with a value and/or a rigor level. At S302, the outputs of S102 for determining the CVS are outputs. The outputs may include, but are not limited to, recommended differentiation parameters, i.e., based on the types of CVS's by disease area, RWW suggested scoring, i.e., how real is the asset based on the importance scores of the CVS. A CVS report summarizing needs by customer group, importance and rigor scores can also be generated at S302.

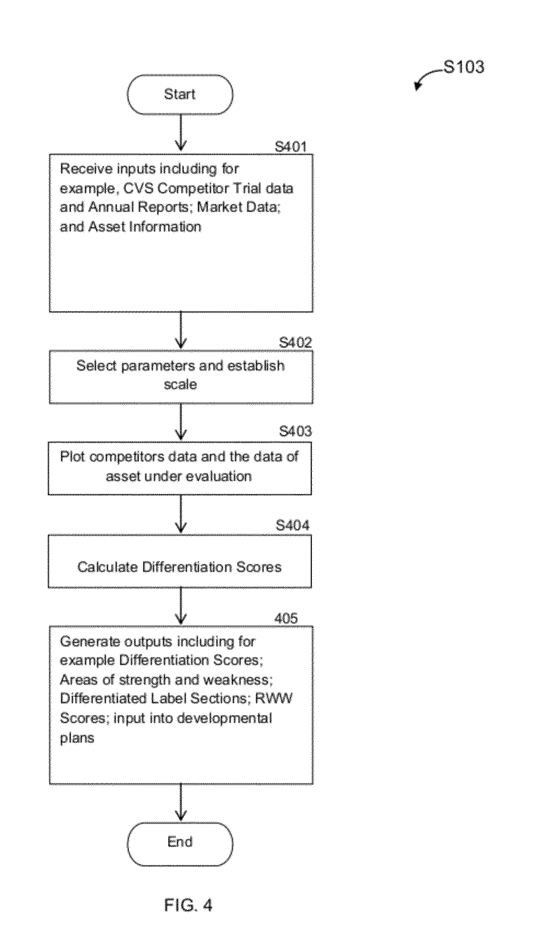

FIG. 4 is an exemplary and non-limiting schematic diagram of the HDI process preformed during S103. At S401, the HDI information is initially pre-populated to provide the inputs to the processing steps. The inputs are pre-populated based on assets in the same disease area. To begin the HDI process one or more parameters are selected and scaled based on the CVS's and on typical parameters used for this therapeutic class and disease area (S402). This is performed via automatic connections from CVS type (e.g., efficacy, cost, convenience, tolerability, and safety) and most commonly used parameters used in the CVS type and in the disease area or therapeutic class. Scales are established for each parameter from the lowest/worse point of data currently available to the best or target. Scales are often in percentage or absolute numbers, but can also be other choices (e.g., oral versus intravenous (IV), once a day versus 2 times).

At S403, for competing products (in-line or pipe-line) the differentiation process plots the data for each parameter (where they fall on the scale). The user may review and update the HDI information for their asset (e.g., new trial data, changes in the target). The user may also review the competitive products (e.g., new information, changes in the market, etc.) for this disease area.

The degree of differentiation for each parameter is calculated at S404 to report parameter differentiation scores and an overall differentiation score. At 405, the outputs of the HDI process are generated. These outputs may include, for example, differentiation scores, areas of strength and weakness, differentiated label sections, RWW scores, and so on. The outputs may be displayed to the user and saved in the database.

As mentioned above, the process 100 shown in FIG. 1 automatically populates label claim information for competitors based on past and updated competitor information for this disease area and asset, as well as recommended label claim information for this Asset based on previous Assets in the same disease area.

As the asset development progresses, the user updates and maintains this information to ensure the differentiation characteristics of this asset are reflected in the Label claims to maximize the market position and the asset's representation.

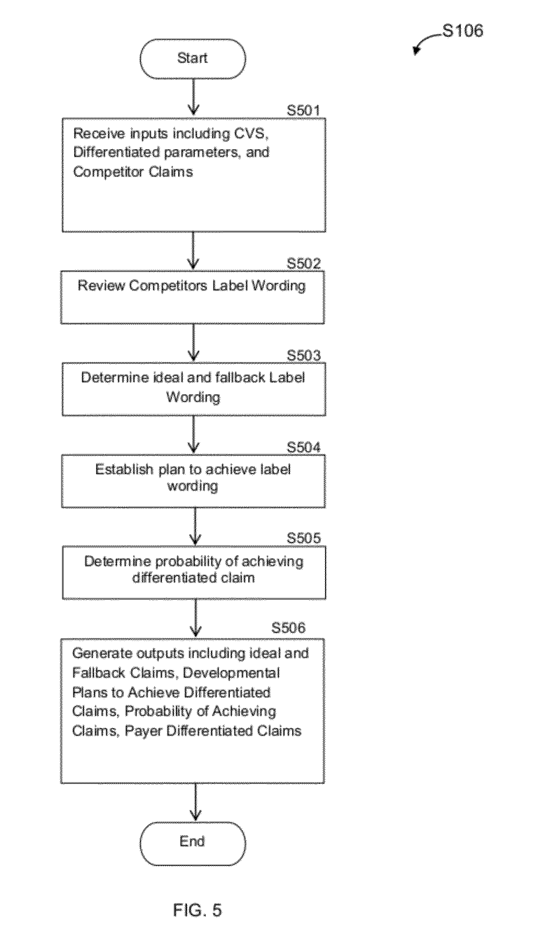

FIG. 5 is an exemplary and non-limiting schematic diagram of the label differentiation process preformed during S106 of FIG. 1. Differentiation in the market is not established unless it is stated in the wording of the label. Inputs including CVS, differential parameters, and competitor claims are received at S501. The label differentiated process S106 assists the review of other competing labels (S502). Such labels are automatically populated in the area's label sections that are potential areas of differentiation only. At S503 wording of the one or more differentiated labels is determined. This may be achieve by parsing and syntax analysis of pipeline's assets label wording and published reports. At S504, a set of clinical plans are defined in order to meet the proposed wordings of the one or more labels. In addition, based on the strength of the competing label(s), against the strength of the differentiation score and defined clinical plans, at S505, the probability that the suggested label's wording will be achieved is determined. At S506, the outputs include one or more suggested differentiated labels having high probability of success (e.g., above a predefined threshold are computed).

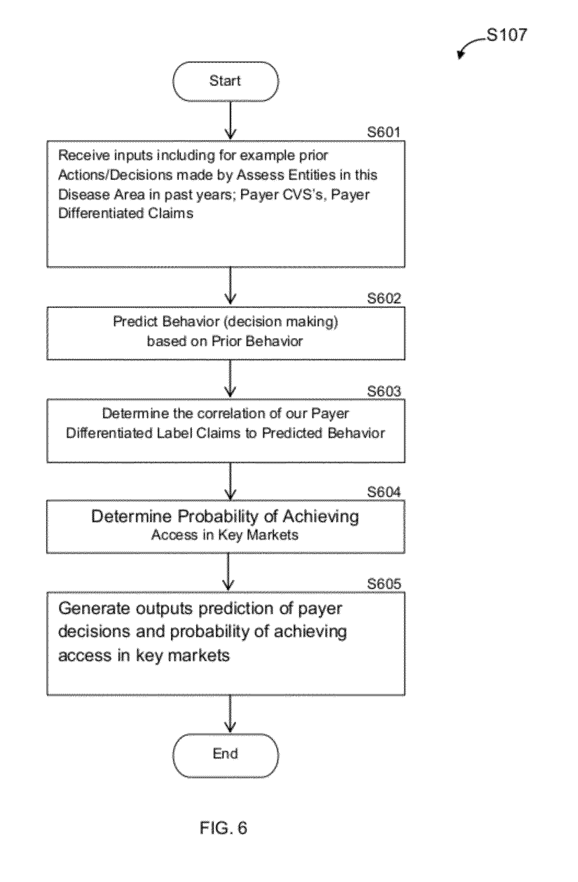

FIG. 6 is an exemplary and non-limiting schematic diagram showing in greater detail S107 of FIG. 1. In today's environment, it is important that we assess if the asset will gain access to patients' insurance plans and be reimbursed at the price requested. The access process S107 assesses the probability the asset gains access to healthcare plans. Gaining access approval to various healthcare plans is critical for new medicines to get to the patient at the desired reimbursement levels. The process begins by assessing the input S601 of prior decisions made by access entities and predicting their future decision making process. The history of decisions made by the access entities is automatically updated in the database by category (efficacy, safety, Tolerability, Convenience and Cost). The inputs include prior actions/decisions made by assess entities in this Disease Area in past years; payer CVS's; and payer differentiated label claims. These inputs are received at S601.

Then, the process S107 predicts what will cause positive decisions in the future (S602). This is also linked closely with the payer CVS statements in S102 and may be included as an input to the access process S107. At S603 the strength of the payer differentiation scores is correlated to the prediction of payer behavior (from S602). Then, at S604, the probability of the asset gaining access in certain markets and the probability of achieving access in the market are determined. At S605, the resulting outputs including the prediction of payer decisions and probability of achieving access in key markets are generated.

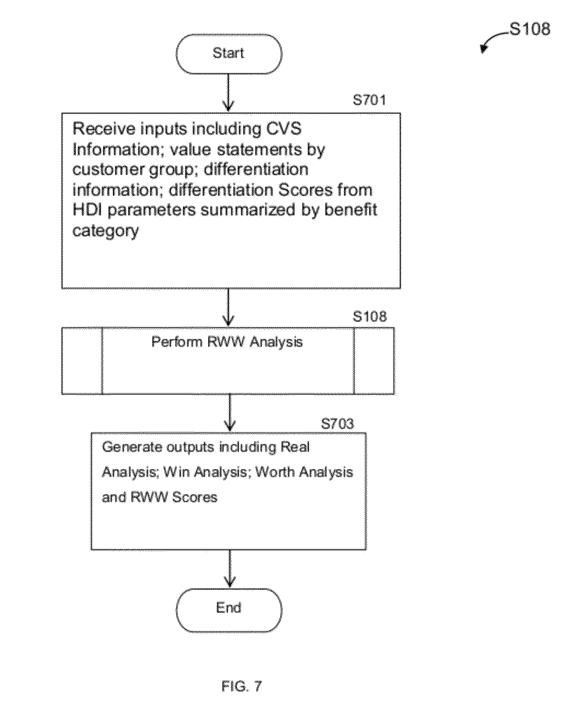

FIG. 7 is an exemplary and non-limiting schematic diagram illustrating S108 of FIG. 1 for scoring the RWW for the asset. The RWW analysis S108 brings together information from different aspects of the system to perform a concise analysis of how real the opportunity is, how likely this asset is to win the market and an estimate of the economic worth (value) of this asset.

As indicated in FIG. 7, information from CVS and HDI are received as inputs at S701 and used to support the real and win analysis. The CVS and HDI information is supplemented with additional data and a series of questions provided to facilitate a thorough RWW analysis process S108.

At S703, the resulting output includes a RWW score that measures how real the opportunity is, how likely the asset is to be successful in the market and the value of the asset is generated and displayed. Such outputs may also be saved in S703.

In one embodiment, the RWW score includes, but is not limited to, how real the asset is, i.e., based on the likelihood it will be prescribed, approved, taken and paid for over other alternatives (linking CVS to Differentiated Parameters). The ability for the asset to win in the market with this asset based on the assets differentiation scores and other questions asked of the team relating to cycle times, investments required, market position, and so on. The ability if is worth the investment based on the assets financial and non-financial awards such as ROI (return on investment) and reputation is also established.

In one embodiment, the RWW are generated based on the HDI, CVS, and label and access processes' outputs shown in FIGS. 3 through 6. The RWW analysis also includes rigor levels. In one embodiment, all of the scoring is compared to averages in this disease area.

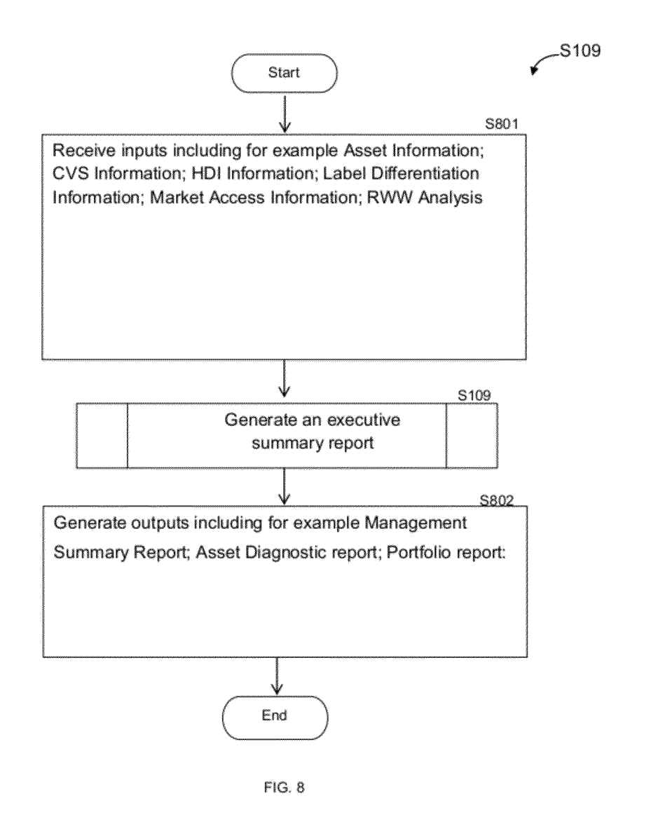

FIG. 8 is an exemplary and non-limiting schematic diagram that illustrates in greater detail S109 of FIG. 1. At S801, the differentiation process summarizes S101-S108 of FIG. 1 are inputs of the executive summary process S109. The executive summary process S109 generates outputs produced at S803. Such outputs may be a variety of different reports including, but not limited to:
Portfolio Report: the portfolio report shows a summary of Assets across the portfolio of Assets currently in development. The Assets are compared and contrasted with each other indicating relative differentiation and value of each asset.
Asset Summary Report: The Differentiation process provides a clear, concise report that summarizes the Asset's position, differentiation, market access positioning and a summary of the RWW analysis.
Asset Diagnostic Report: Provides diagnostic analysis to the Asset Team of information entered into the differentiation process for a single Asset. The Diagnostic report will alert the Asset Team of missing information, data inconsistencies, areas of potential strength and weakness. The Asset Team uses this report to ensure the Asset information is complete and accurate.

Ultimately, the differentiation process generates for the user a set of executive level charts by any graphical means to share, for example, with its governance/investment board to evaluate the future potential of this asset. In addition, error reports are created for the user to review prior to their final presentation to the governance board.

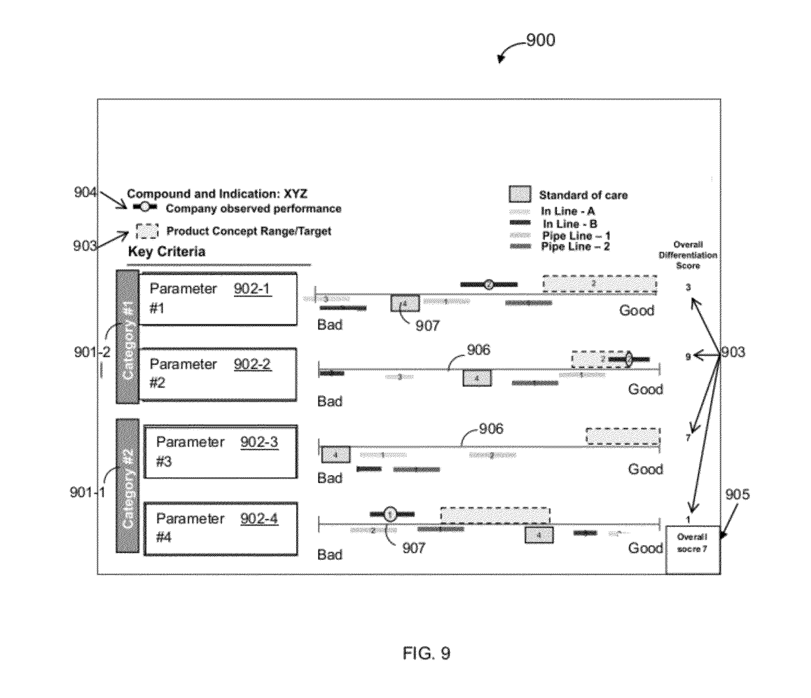

FIG. 9 illustrates an exemplary and non-limiting schematic diagram of the analysis of the HDI 900 according to an embodiment of the invention. The HDI 900 is a comprehensive instrument that provides a single view of a specific feature parameter 902 of the Asset and the targeted performance 903 as well as the observed (actual) performance 904 of the Asset in comparison to competitive products. This presents the user with a quick, intuitive view of this Asset's differentiation for a single Parameter, and multiple Parameters by which to discuss trade offs.

The way to interpret an HDI report 900 may be:
1. Parameters by Category 901-1 and 901-2 are listed on the left side of the screen. The parameters are listed in order of importance, the higher importance is first.
2. Scales are established by a parameter 902, sorted “good” to “bad” relative to their performance. In this example shown in FIG. 9, good parameters are place on the right side of the scale and bad are on the left side.
3. The asset target 903 and observed data 904 is above the line, competing products data is below the line.
4. Even if real data is not available, using rigor levels 907 help determine if the data is based on published information (R4) or rumor/hunch of a competitors pipeline drug (R1).
5. A predefined differentiated position is set to a parameter, so that the parameter will be displayed even if it is significantly tracked compared to the parameter. There may be times the proposed asset has neutral or even negative differentiation.
6. An overall differentiation score 905 for each parameter 902 is also displayed and can be used at a portfolio level to compare this asset to others.
   It should be noted that only a set of the computed parameters are shown in the HDI report 900. The set of displayed parameters are selected based their importance to the evaluation of the asset.

The overall differentiation scores 905 for each parameter 902 is computed as discussed above. In one embodiment, the calculations overall differentiation scores 905 are based on the total range of data on each parameter scale 906, and where the asset's data sits on that scale relative to the others. Assets with data to the far right on a parameter scale 906, with competing data falling to the left, will have a high differentiation score 905 on this parameter 902. Conversely, if the asset data is to the left of all others on scale 906, we are said to have “negative differentiation”.

It should be noted that the overall differentiation scores are important particularly if the respective parameter has a high correlation to an important CVS (established in S102).

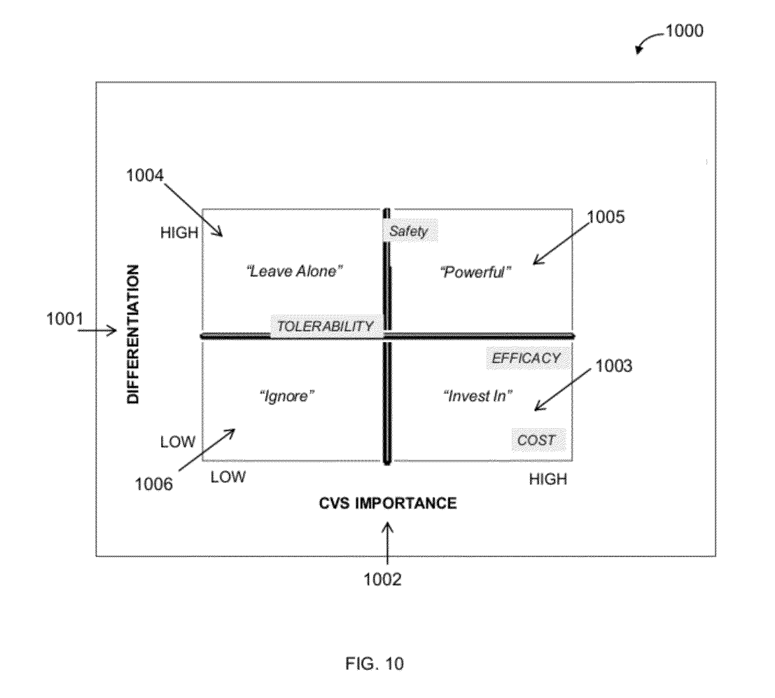

FIG. 10 is an exemplary and non-limiting schematic diagram for a CVS Value/HDI Differentiation analysis report 1000 generated by the according to an embodiment of the invention. To best determine if and how continued investments should be made on an asset, it is important to see how well the areas of parameter differentiation match the unmet need in the market. With this aim, the parameter differentiation scores 1001 are compared against the CVS Important levels 1002. This analysis indicates the degree of alignment between the market need (CVS) and the performance characteristics of the Asset (HDI Differentiation Score). Ideally, the Asset will be significantly differentiated on parameters that are of highest importance to the market. From chart shown in FIG. 10, it can be determined that parameters 1003 high in differentiation that are also areas of importance to the Customers. Parameters 1004 that have strong differentiation in areas not that important to customers should be just left alone, i.e., no further clinical testing should be done. It is an area of differentiation that is not really important to the customer. It will not be a strong competitive advantage. Parameters 1005 of medium or weak differentiation in areas of great importance to the customers should be further invested in to determine if greater differentiation should be established. Parameters 1006 with low differentiation in areas not important to the customers should be documented and/or ignored. Typically, if there are no parameters falling in the top right quadrant, further investment in this asset should be questioned.

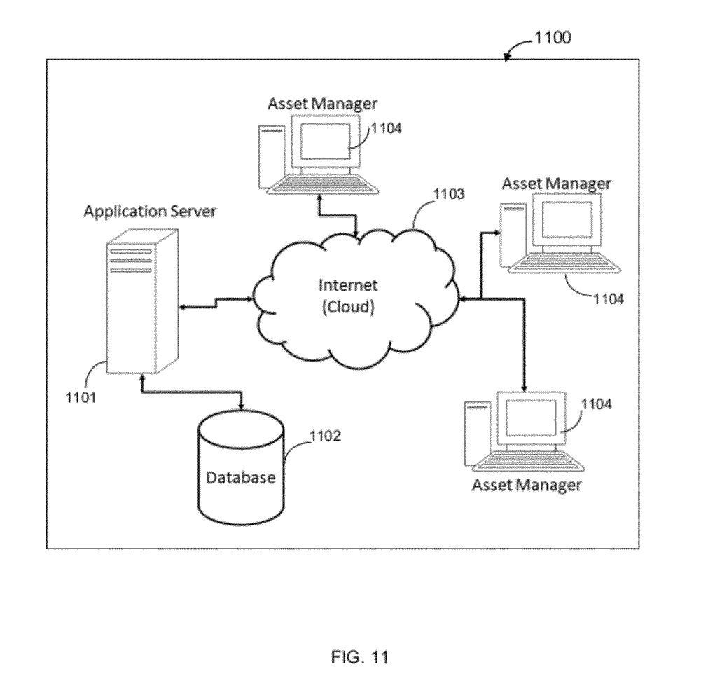

FIG. 11 depicts an exemplary and non-limiting block diagram of an embodiment of the system 1100 to support the invention. In one embodiment, the system 1120 is implemented on server 1101 as a data-as-a-service (DaaS) application through a database 1102. The server 1101 includes a processor and a non-transitory memory coupled to the processor and configured to store executable instructions that when executed by the processor causes to the operation of the asset differentiation process 100 described in detail above.

The database may be any form of non-transitory storage medium. The database 1102 may include the collocated assets information, the generate reports, and any results generated during the different stage of processing. The server 1101 is connected to the database 1102.

A plurality of users can access the server 1101 by means of clients 1104 through a network 1103. The network 1103 may be, but is not limited to, the Internet, a local area network (LAN), the network may be wired or wireless network. A client 1104 may be a personal computer, a tablet computer, a smart phone, a laptop computer, and the like. In certain embodiments, a client 1104 is can access the database 1102 and execute the differentiation process locally on a client 1104.

The various embodiments of the invention can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A computer implemented method for determining pharmaceutical asset market potential, comprising:
collecting asset information about in-line and proposed pipeline products of pharmaceutical assets by a therapeutic category;
determining an unmet need for the proposed pharmaceutical asset by evaluating a plurality of customer value statements (CVS) based on the therapeutic category;
computing a differentiation score based on the plurality of CVS and comparing a strength of the proposed pharmaceutical asset against existing competitor pharmaceutical assets in the therapeutic category; and
generating an executive summary report of the proposed pharmaceutical asset market potential base, in part, computed differentiation score.

2. The method of claim 1, wherein collecting asset information further comprising:
collecting demographic information about the proposed pharmaceutical asset;
collecting information about the therapeutic category; and
collecting information about previous pharmaceutical assets in the same therapeutic category.

3. The method of claim 1, wherein determining the unmet need further comprising:
recommending a plurality of parameters based on the therapeutic category that differentiate the proposed pharmaceutical asset from existing competitor pharmaceutical assets, wherein the plurality of parameters include at least one of pharmaceutical asset efficacy, a pharmaceutical asset safety, a pharmaceutical asset tolerability, a pharmaceutical asset convenience and a pharmaceutical asset cost;
recommending an RWW score goal based, in part, on the plurality of parameters; and
generating a CVS report.

4. The method of claim 3, wherein determining the unmet need further comprising:
processing a Healthcare Differentiation Instrument (HDI) based on the plurality of parameters and on the plurality of CVS;
comparing the plurality of differentiation parameters with competitor pharmaceutical assets; and
generating a plurality of parameter differentiation scores and at least one overall differentiation score.

5. The method of claim 4, further comprising:
computing a Real/Win/Worth (RWW) score to determine a probability of success of the pharmaceutical asset in the therapeutic category based, in part, on the computed differentiation score and CVS; and
computing a Label Differentiation score to determine the strength of a proposed pharmaceutical labeling compared to existing competitor product labeling in the therapeutic category.

6. The method of claim 5, wherein computing the label differentiation score further comprising:
reviewing a plurality of labeling of competing pharmaceutical assets;
creating a proposed labeling for the proposed pharmaceutical asset; and
determining the probability of success of the proposed labeling based on the plurality of competing plurality of labeling of competing pharmaceutical assets, the proposed labeling, and the differential score.

7. The method of claim 5, further comprising:
evaluating a healthcare plan payer behavior by assessing a probability the proposed pharmaceutical asset gains access to a pharmaceutical market.

8. The method of claim 7, wherein evaluating the healthcare plan payer behavior further comprising:
correlating prior healthcare plan payer behavior, the plurality of CVS, and the differentiation score;
resulting in a prediction of the Healthcare Plan Payer behavior; and
generating the probability of the proposed pharmaceutical asset access to the pharmaceutical market.

9. The method of claim 5, wherein computing the RWW score further comprising:
analyzing the plurality of CVS and the plurality of differentiation parameters to determine the RWW score.

10. The method of claim 7, wherein generating the executive summary report further comprising:
processing at least one of the proposed pharmaceutical asset, the CVS, the HDI, the label differentiation score, the healthcare plan payer behavior, and the RWW score to generate the executive summary report.

11. The method of claim 10, wherein the executive summary report further includes at least one of: a management summary report, an asset diagnostic report, and a portfolio report.

12. A non-transitory computer readable medium having stored thereon instructions for causing one or more processing units to execute the method according to claim 1.

13. A system for determining pharmaceutical asset market potential, comprising:
at least one application server;
at least one non-transitory storage device in communication with the at least one application server;
a pharmaceutical asset differentiation process residing on the at least one application server and executed therein, and accessed by a at least one computer system, wherein the least one application server is configured to perform the pharmaceutical asset differentiation process including:
collecting asset information of in-line and proposed pipeline products of pharmaceutical assets by a therapeutic category;
determining an unmet need for the proposed pharmaceutical asset by evaluating a plurality of customer value statements (CVS) based on the therapeutic category;
computing a differentiation score based on the plurality of CVS and comparing a strength of the proposed pharmaceutical asset against existing competitor pharmaceutical assets in the therapeutic category; and
generating an executive summary report of the proposed pharmaceutical asset market potential base, in part, computed differentiation score.

14. The system of claim 13, wherein the at least one application server is further configured to determine the unmet need by:
recommending a plurality of parameters based on the therapeutic category that differentiate the proposed pharmaceutical asset from existing competitor pharmaceutical assets, wherein the plurality of parameters include at least one of pharmaceutical asset efficacy, a pharmaceutical asset safety, a pharmaceutical asset tolerability, a pharmaceutical asset convenience and a pharmaceutical asset cost;
recommending an RWW score goal based, in part, on the plurality of parameters; and
generating a CVS report.

15. The system of claim 14, wherein the at least one application server is further configured to:
compute a Real/Win/Worth (RWW) score to determine a probability of success of the pharmaceutical asset in the therapeutic category based, in part, on the computed differentiation score and CVS; and
compute a Label Differentiation score to determine the strength of a proposed pharmaceutical labeling compared to existing competitor product labeling in the therapeutic category.

16. The system of claim 15, wherein the at least one application server is further configured to compute the label differentiation score by:
reviewing a plurality of labeling of competing pharmaceutical assets;
creating a proposed labeling for the proposed pharmaceutical asset; and
determining the probability of success of the proposed labeling based on the plurality of competing plurality of labeling of competing pharmaceutical assets, the proposed labeling, and the differential score.

17. The system of claim 15, wherein the at least one application server is further configured to:
evaluate a healthcare plan payer behavior by assessing a probability the proposed pharmaceutical asset gains access to a pharmaceutical market.

18. The system of claim 17, wherein the at least one application server is further configured to generate the executive summary report by:
processing at least one of the proposed pharmaceutical asset, the CVS, the HDI, the label differentiation score, the healthcare plan payer behavior, and the RWW score to generate the executive summary report.

19. The system of claim 18, wherein the executive summary report further includes at least one of: a management summary report, an asset diagnostic report, and a portfolio report.

20. The system of claim 13, wherein at least one of the executive summary report, the CVS, the HDI, the label differentiation scores, the healthcare plan payer behavior, and the RWW score are stored in the at least one non-transitory storage device for future processing.
